(19) United States
(12) Patent Application Publication
(10) Pub. No.: US 2006/0051582 A1
(43) Pub. Date: Mar. 9, 2006

(54) Thermoplastic resin composition and molding consisting of the composition

(75) Inventors: Hiroshi Uehara, Ichihara-shi (JP); Tomohiko Kimura, Yamaguchi (JP); Satoru Moriya, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsui Chemicals, Inc, Minato-ku, Tokyo (JP)

(21) Appl. No.: 10/517,136

(22) PCT Filed: Jun. 26, 2004
(86) PCT No.: PCT/JP03/08076

§ 371 Date: Dec. 7, 2004

(30) Foreign Application Priority Data
Jul. 1, 2002 (JP) 2002-192375

(51) Int. Cl. B32B 15/08; B32B 15/02

(52) U.S. Cl. 428/407; 428/375

(57) ABSTRACT

An object of the invention is to provide a resin composition which is excellent in flame-resistance effect, good in flexibility/softness, and high in whiteness, and a molding thereof, in particular, an electric wire insulator and/or sheath. The present invention is a thermoplastic resin composition, in which in the case of using samples of an insulated electric wire 3.0 mm in finishing diameter wherein the periphery of a conductor (1.35 mm in outer diameter) made of seven twisted soft copper wires each having a diameter of 0.45 mm is coated with the thermoplastic resin composition of 0.8 mm in thickness to carry out a flame-resistance test at flame-resistance test angles θ of 45°, 60°, and 90°, the maximum angle A out of the flame-resistance test angles θ at which the samples are spontaneously extinguished within 60 seconds from the ignition thereof satisfies the following expression (1):
A≧1.8×σ+13.4 (1)

### BACKGROUND OF THE INVENTION

1. Field of the Invention

The invention relates to a thermo plastic resin composition and a molding thereof, more specifically a thermoplastic resin composition particularly suitable for the material of an electric wire insulator or sheath, and a molding thereof.

2. Description of the Related Art

Hitherto, polyvinyl chloride (PVC) has widely been used for the sheath material and partial insulated material of electric wires, and the flexibility, flame resistance and electric non-conductance thereof have been evaluated highly.

PVC in general contains a plasticizer. Thus, if the plasticizer is lost by heating or the like, PVC is easily cured, and further chlorine-based gas is generated when PVC is burned. Therefore, it has been desired in recent years to develop electric wire material which can be substituted for PVC.

Under such a situation, various flame-resistant resin compositions containing, as the base thereof, an ethylenic polymer such as polyethylene are suggested.

U.S. Pat. No. 6,232,377 describes a flame-resistant resin composition comprising a specific ethylenic copolymer selected from ethylene/vinyl ester copolymer, ethylene/α,β-unsaturated carboxylic acid copolymer and low density polyethylene, and other components and further comprising a metal hydroxide, a triazine compound and a specific flame-resistant compound.

However, these ethylenic polymers have a problem that if the amount of the added inorganic compound such as the metal hydroxide is increased to make the flame-resistance effect of the polymers high, the flexibility and softness thereof fall easily.

Besides the above-mentioned ethylenic polymer composition, for example, WO 01/12708 describes a composition comprising a specific interpolymer, a typical example of which is an ethylene/styrene interpolymer, a filler and others and having improved flame-resistance.

However, this composition is insufficient in flame-resistance effect, as well. On the basis of the present inventor's finding, a resin composition wherein magnesium hydroxide is incorporated as an inorganic filler into the interpolymer has a problem that the composition is brownish and poor in external appearance (whiteness).

### SUMMARY OF THE INVENTION

An object of the invention is to provide a resin composition which is excellent in flame-resistance effect, good in flexibility/softness, and high in whiteness, and a molding thereof, in particular, an electric wire insulator and/or sheath.

The present invention is a thermoplastic resin composition, in which in the case of using samples of an insulated electric wire 3.0 mm in finishing diameter wherein the periphery of a conductor (1.35 mm in outer diameter) made of seven twisted soft copper wires each having a diameter of 0.45 mm is coated with the thermoplastic resin composition of 0.8 mm in thickness to carry out a flame-resistance test at flame-resistance test angles θ of 45°, 60°, and 90°, the maximum angle A out of the flame-resistance test angles θ at which the samples are spontaneously extinguished within 60 seconds from the ignition thereof satisfies the following expression (1):
A≧1.8×σ+13.4 (1)
wherein a is the torsional rigidity (MPa) of a sheet 2 cm in thickness made of the thermoplastic resin composition at 23° C.

The thermoplastic resin composition in the present invention preferably satisfies the following expression (2):
A≧1.9×σ+15.4 (2)
wherein A and σ have the same meanings as described above (1).

The above-mentioned flame-resistant composition is suitable for the material of various moldings, in particular, an electric wire coating or sheath.

### BRIEF DESCRIPTION OF THE DRAWINGS

FIG. 1 is a schematic view of a flame-resistance test in the present invention. Reference numbers 1 and 2 represent an insulated electric wire, and a burner, respectively.

FIG. 2 is a graph showing a relationship between the torsional rigidity of each thermoplastic resin composition described in Table 2 and flame-resistance test angles.

### DETAILED DESCRIPTION OF THE INVENTION

Formation of Samples of an Insulated Electric Wire

A melting extruder (product name: Laboplast Mill, manufactured by Toyo Seiki Seisaku-Sho, Ltd.) to which an electric wire coating dice is fitted is used to coat the periphery of a conductor (1.35 mm in outer diameter) made of seven twisted soft copper wires each having a diameter of 0.45 mm with a polymer composition of the present invention 0.8 mm in thickness at a dice temperature of 220° C., a screw rotational rate of 30 rpm, and an extruding amount of 1.6 to 1.8 kg/h, so as to yield samples of an insulated electric wire which has a finishing diameter of 3.0 mm.

Flame-Resistance Test Method

The flame-resistance of the insulated coating of the resultant insulated electric wire samples is evaluated by the following method:

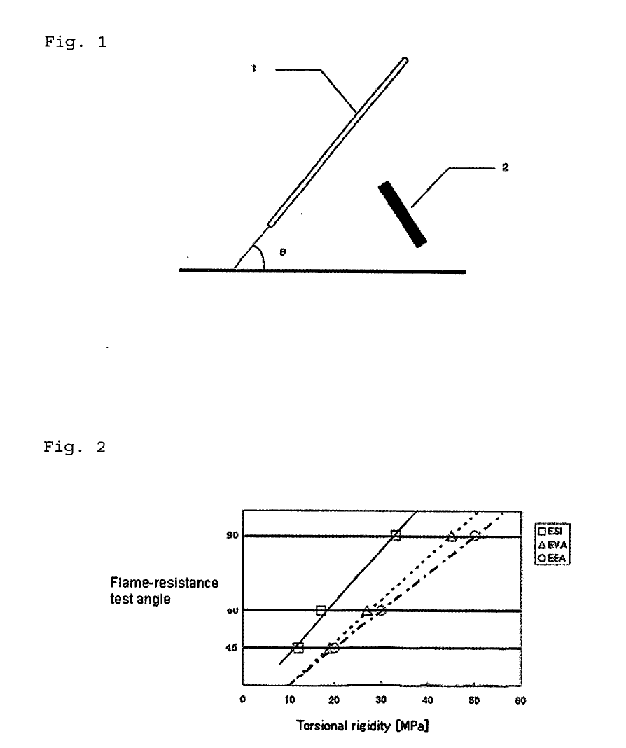

As illustrated in FIG. 1, an insulated electric wire 1 having a length of 17 inches, which is one of the samples, is set into a chamber (not illustrated) of a testing device. The angle made between the bottom face and the insulated electric wire 1 is defined as the flame-resistance test angle (θ) of the sample.

Next, a burner 2 arranged in the front of the insulated electric wire 1 is ignited, and flames therefrom are brought into contact with a position of the insulated electric wire 1 which is 3 inches higher than the bottom end of the wire at an angle of 70°. After the ignition of the wire is recognized, flames from the burner 2 are continued to be brought into contact with the wire 1 for 5 seconds, and then the flames are taken away. It is then checked whether or not the wire 1 is spontaneously extinguished within 60 seconds. The result, together with the angle θ, is recorded.

This testing operation is made 3 times. The sample which is spontaneously extinguished at each of the testing operations is decided as a sample accepted for this inclination test about the angle θ (i.e., the θ° inclination test). As a sample passes the flame-resistance test about a higher inclination angle θ, this sample has a higher flame-resistance.

In the present invention, the above-mentioned samples are subjected to such testing operations about the angles θ of 45°, 60° and 90°. The maximum angle out of the angles θ at which the samples pass the test operations is defined as A (corresponding to the left-hand side of the expression (1) or (2)).

Specifically, if the samples pass the 90° inclination test, A is set to 90.

If the samples do not pass the 90° inclination test but pass a similar 60° inclination test, A is set to 60.

If the samples do not pass the 60° inclination test but pass a similar 45° inclination test, A is set to 45.

The following describes the right-hand sides of the expressions (1) and (2).

σ is the torsional rigidity of a sheet 2 cm in thickness made of the thermoplastic resin composition at 23° C.

Measurement of the Torsional Rigidity

A Kraschberg type flexible degree tester manufactured by Toyo Seiki Seisaku-Sho, Ltd. is used to measure the torsional rigidity of the same thermoplastic resin composition sheet as used in the flame-resistance test at 23° C. in accordance with JIS K6745.

The thermoplastic resin composition which satisfies the expression (1), preferably satisfies the expression (2), is typically the following thermoplastic resin composition:

a thermoplastic resin composition comprising:

(A) 25 to 59.9% by weight of at least one substantially random interpolymer comprising:

(1) 1 to 99% by mol of a polymer unit derived from
(a) at least one aromatic vinyl or vinylidene monomer, or
(b) at least one hindered aliphatic or alicyclic vinyl or vinylidene monomer, or
(c) a combination of at least one aromatic vinyl or vinylidene monomer and at least one hindered aliphatic or alicyclic vinyl or vinylidene monomer, and
(2) 1 to 99% by mol of a polymer unit derived from at least one α-olefin having 2 to 20 carbon atoms,
   (B) 40 to 60% by weight of magnesium hydroxide, and
   (c) 0.1 to 20% by weight of a triazine compound.
   Interpolymer (A)

The interpolymer (A) used in the present invention is at least one substantially random interpolymer comprising:

(1) 1 to 99% by mol of a polymer unit derived from

(a) at least one aromatic vinyl or vinylidene monomer, or

(b) at least one hindered aliphatic or alicyclic vinyl or vinylidene monomer, or

(c) a combination of at least one aromatic vinyl or vinylidene monomer and at least one hindered aliphatic or alicyclic vinyl or vinylidene monomer, and

(2) 1 to 99% by mol of a polymer unit derived from at least one α-olefin having 2 to 20 carbon atoms.

The term “interpolymer” used herein means a copolymer when at least two monomers are polymerized to prepare an interpolymer.

The term “copolymer” used herein means a polymer when at least two monomers are polymerized to prepare a copolymer.

The term “substantially random” in the substantially random interpolymer, which comprises the specified α-olefin, and an aromatic vinyl monomer, aromatic vinylidene monomer, hindered aliphatic vinyl monomer, hindered alicyclic vinyl monomer, hindered aliphatic vinylidene monomer or hindered alicyclic vinylidene monomer used herein, means that the monomer distribution of the interpolymer can be described in accordance with a “Bernoulli statistical model” or a “first or second order Markovian statistical model”, as described on pp. 71-78 of “POLYMER SEQUENCE DETERMINATION, Carbon-13NMR Method”, published by Academic Press in New York in 1977 and written by J. C. Randall.

In the substantially random interpolymer which comprises at least one α-olefin having 2 to 20 carbon atoms and an aromatic vinyl or vinylidene monomer, the amount of the aromatic vinyl or vinylidene monomer in the form of blocks having 4 or more units is preferably 15% or less of the total amount of the aromatic vinyl or vinylidene monomer. More preferably, this interpolymer is not characterized by high-degree isotacticity or syndiotacticity. This means that the area of peaks corresponding to methylene and methine carbon atoms of the main chain which exhibit either mesodiad sequence or racemidiad sequence in the ¹³C NMR spectrum of the substantially random interpolymer should not exceed 75% of the total area of peaks of methylene and methine carbon atoms in the main chains.

The interpolymer suitable for preparing the thermoplastic resin composition according to the present invention may be an interpolymer obtained by polymerizing one or more α-olefins with one or more aromatic vinyl or vinylidene monomers and/or one or more hindered aliphatic or alicyclic vinyl or vinylidene monomers, but is not limited to this.

Preferable examples of the α-olefins are α-olefins having 2 to 20 carbon atoms, preferably 2 to 12 carbon atoms, even more preferably 2 to 8 carbon atoms. Of the olefins, particularly preferable are ethylene, propylene, 1-butene, 4-methyl-l-pentene, 1-hexene, and 1-octene. These α-olefins do not contain any aromatic group.

An example of the aromatic vinyl or vinylidene monomer suitable for being used in the production of the interpolymer used in the present invention may be a monomer by the following formula:

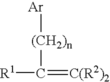

In this formula, R¹ is an atom or group selected from the group consisting of a hydrogen atom and alkyl groups having 1 to 4 carbon atoms, and is preferably a hydrogen atom or a methyl group.

R² s are each independently an atom or group selected from the group consisting of a hydrogen atom and alkyl groups having 1 to 4 carbon atoms, and is preferably a hydrogen atom or a methyl group.

Ar is a phenyl group, or a phenyl group substituted with 1 to 5 substituents selected from halogen atoms, alkyl groups having 1 to 4 carbon atoms and haloalkyl groups having 1 to 4 carbon atoms.

n is an integer of 0 to 4, preferably 0 to 2, more preferably 0.

Specific examples of the aromatic monovinyl or monovinylidene monomer include styrene, vinyl toluene, α-methylstyrene, t-butylstyrene, chlorostyrene, and isomers of all of them. Particularly preferable example of the aromatic monovinyl monomer or monovinylidene monomer include styrene, and lower-alkyl-substituted or halogen-substituted derivatives thereof. The monomer is preferably styrene, α-methylstyrene, a lower-alkyl (alkyl having 1 to 4 carbon atoms)-substituted or phenyl-ring-substituted derivative of styrene (such as o-, m- or p-methylstyrene), ring-substituted styrene, p-vinyltoluene, or any mixture thereof. The aromatic monovinyl monomer or monovinylidene monomer is more preferably styrene.

The above-mentioned wording “hindered aliphatic or alicyclic vinyl or vinylidene compound” means any addition-polymerizable vinyl or vinylidene monomer corresponding to a compound represented by the following formula:

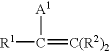

In this formula, A¹ is a bulky aliphatic or alicyclic substituent having 20 or less carbon atoms.

R¹ is an atom or group selected from the group consisting of a hydrogen atom and alkyl groups having 1 to 4 carbon atoms, and is preferably a hydrogen atom or a methyl group.

R²'s are each independently an atom or group selected from the group consisting of a hydrogen atom and alkyl groups having 1 to 4 carbon atoms, and is preferably a hydrogen atom or a methyl group.

R¹ and A¹ may be combined with each other to form a ring system.

The wording “bulky” means that a monomer having this aliphatic or alicyclic substituent cannot be ordinarily addition-polymerized at a rate equal to that of ethylene polymerization with a standard Ziegler-Natta catalyst.

The hindered aliphatic or alicyclic vinyl or vinylidene compound is preferably a monomer wherein one of carbon atoms which each have an ethylenic unsaturated bond is tertiary- or quaternary-substituted. Examples of this substituent include alicyclic groups such as cyclohexyl, cyclohexenyl and cyclooctenyl, and cycloalkyl or aryl-substituted derivatives thereof. The hindered aliphatic or alicyclic vinyl or vinylidene compound is most preferably any one selected from various vinyl-ring-substituted isomeric derivatives of cyclohexane and substituted cyclohexane, and 5-ethylidene-2-norbornene. Particularly preferable are 1-, 3- and 4-vinylcyclohexene.

The interpolymer used in the present invention, which is obtained by polymerizing one or more α-olefins with one or more aromatic vinyl or vinylidene monomers and/or one or more hindered aliphatic or alicyclic vinyl or vinylidene monomers, is a substantially random polymer. This interpolymer usually comprises 1 to 99% by mol, preferably 5 to 65% by mol, more preferably 5 to 50% by mol of at least one aromatic vinyl or vinylidene monomer and/or hindered aliphatic or alicyclic vinyl or vinylidene monomer; and 1 to 99% by mol, preferably 35 to 95% by mol, more preferably 50 to 95% by mol of at least one α-olefin having 2 to 20 carbon atoms.

The number-average molecular weight (Mn) of the interpolymer (A) is usually 10,000 or more, preferably from 20,000 to 1,000,000, more preferably from 50,000 to 500,000.

Incidentally, in the middle of the production of the substantially random interpolymer, the aromatic vinyl or vinylidene monomer is homo-polymerized at a raised temperature, whereby some amount of an atactic aromatic vinyl or vinylidene homopolymer can be produced. In general, the presence of the aromatic vinyl or vinylidene homopolymer is not preferable for the object of the present invention, and cannot be ignored. If desired, the aromatic vinyl or vinylidene homopolymer can be separated from the interpolymer by an extraction technique such as a technique of using a non-solvent for the interpolymer or the aromatic vinyl or vinylidene homopolymer in accordance with desire, so as to precipitate the given component selectively from the solution. For the object of the present invention, it is desired that the amount of the aromatic vinyl or vinylidene homopolymer present is 20% or less, preferably 15% or less by weight of the whole of the interpolymer.

The substantially random interpolymer can be produced as described in U.S. application Ser. No. 07/545,403 filed on Jul. 3, 1990 by James C. Stevens et al. (corresponding to EP-A-0,416,815), and U.S. application Ser. No. 08/469,829 filed on Jun. 6, 1995 and granted (U.S. Pat. No. 5,703,187). All of the disclosures of these U.S. Applications are incorporated herein. Preferred conditions for operating these polymerization reactions are as follows: a pressure of atmospheric pressure to 3,000 atmospheres and a temperature of −30 to 200° C. When the polymerization of the monomers and the removal of unreacted portions of the monomers are conducted at a higher temperature than the automatically polymerizing temperature of each of the monomers, some amount of a homopolymer maybe produced by free radical polymerization.

Preferable examples of the catalyst and the method for producing the substantially random interpolymer used in the present invention are disclosed in U.S. application Ser. No. 07/545,403 filed on Jul. 3, 1990, corresponding to EP-A-416,815; U.S. application Ser. No. 07/702,475 filed on May 20, 1991, corresponding to EP-A-514,828; U.S. application Ser. No. 07/876,268 filed on May 1, 1992, corresponding to EP-A-520,732; U.S. application Ser. No. 08/241,523 filed on May 12, 1994 (U.S. Pat. No. 5,470,993); and U.S. Pat. Nos. 5,055,438, 5,057,475, 5,096,867, 5,064,802, 5,132,380, 5,189,192, 5,321,106, 5,347,024, 5,350,723, 5,374,696, 5,399,635and5,556,928. All disclosures thereof are incorporated herein.

The substantially random α-olefin/aromatic vinyl or vinylidene interpolymer used in the present invention can also be produced by a method disclosed in WO 95/32095 (W. R. Grace & Co) and invented by John C. Bradfute et al., a method disclosed in WO 94/00500 (Exxon Chemical Patents. Inc.) and invented by R. B. Pannell, or a method described in “Plastics Technology”, p. 25 (September, 1992). All disclosures thereof are incorporated herein.

Preferable is also a substantially random interpolymer comprising at least one α-olefin/aromatic vinyl/aromatic vinyl/α-olefin tetrad disclosed in U.S. application Ser. No. 08/708,809 filed by Francis J. Timmers et al. on Sep. 4, 1996 (U.S. Pat. No. 5,879,149). The interpolymer has additional signals having a strength three times larger than peak-to-peak noises. These signals make their appearance in chemical shift ranges of 43.75 to 44.25 ppm and 38.0 to 38.5 ppm. The peaks are observed, in particular, at 44.1, 43.9 and 38.2 ppm. Proton test NMR experiments demonstrate that the signal in the chemical shift range of 43.75 to 44.25 ppm originates from methine carbons and the signal in the range of 38.0 to 38.5 ppm originates from methylene carbons.

The pseudo random interpolymer used in the present invention, which comprises an aliphatic α-olefin and an aromatic monovinyl or monovinylidene compound, is disclosed in U.S. application Ser. No. 545,403 filed on Jul. 3, 1990 (corresponding to EP-A-0416815).

The interpolymer can be produced by polymerization at a temperature of −30 to 250° C. in the presence of a catalyst as represented by a formula illustrated below and preferably an optional co-catalyst. 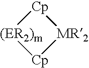
wherein Cp′s are each independently a substituted cyclopentadienyl group n-bonded to M, E is a carbon or silicon atom, M is a metal of the group IV in the periodic table, preferably Zr or Hf, more preferably Zr, R′s are each independently a hydrogen atom, or a hydrocarbyl, silahydrocarbyl or hydrocarbylsilyl group which has 30 or less, preferably 1 to 20, more preferably 1 to 10 carbon atoms or silicon atoms, R″s are each independently a hydrogen or halogen atom, or a hydrocarbyl, hydrocarbyloxy, silahydrocarbyl or C group which has 30 or less, preferably 1 to 20, more preferably 1 to 10 carbon atoms or silicon atoms, or two R″s are combined with each other to C1-10 hydrocarbyl substituted 1,3-butadiene, and m is 1 or 2. The substituted cyclopentadienyl group is in particular preferably a group represented by the following formula: 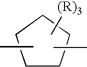
wherein R′s are each independently a hydrogen atom, or a hydrocarbyl, silahydrocarbyl or hydrocarbylsilyl group which has 30 or less, preferably 1 to 20, more preferably 1 to 10 carbon atoms or silicon atoms, or two R′s are combined to form a bivalent derivative of these groups. Preferably, R′s are each independently hydrogen, methyl, ethyl, propyl, butyl, pentyl, hexyl, benzyl, phenyl or silyl (which may, if the group has isomers, be any one of the isomers), or two R′s are combined with each other (if possible), so as to form a condensed ring system such as indenyl, fluorenyl, tetrahydroindenyl, tetrahydrofluorenyl, or octahydrofluorenyl.

Particularly preferable and specific examples of the catalyst include:

racemic (dimethylsilanediyl)-bis-(2-methyl-4-phenylindenyl)zirconium dichloride,

racemic (dimethylsilanediyl)-bis-(2-methyl-4-phenylindenyl)zirconium 1,4-diphenyl-1,3-butadiene,

racemic (dimethylsilanediyl)-bis-(2-methyl-4-phenylindenyl)zirconium di-C1-4 alkyl,

racemic (dimethylsilanediyl)-bis-(2-methyl-4-phenylindenyl)zirconium di-C1-4 alkyl,

racemic (dimethylsilanediyl)-bis-(2-methyl-4-phenylindenyl)zirconium di-C1-4 alkoxide, and

combinations thereof.

The following titanium-based constrained geometry catalysts may be used:

[N-(1,1-dimethylethyl)-1,1-dimethyl-1-[(1,2,3,4,5-η)-1,5,6,7-tetrahydro-s-indacene-1-yl]silaneaminate(2-)-N]titanium dimethyl;

(1-indenyl)(t-butylamide)dimethyl-silane titanium dimethyl;

((3-t-butyl)(1,2,3,4,5-η)-1-indenyl)(t-butylamide)dimethylsilane titanium dimethyl; and

(3-isopropyl)(1,2,3,4,5-η)-1-indenyl)(t-butylamide)dimethylsilane titanium dimethyl; or any combination thereof.

Another example of the process for producing the interpolymer used in the present invention is described in Longo and Grassi., Makromol. Chem., Vol. 191, 2387-2396 (1990) and D'Anniello et al., Journal of Applied Polymer Science, Vol. 58, 1701-1706 (1995). An ethylene styrene copolymer is prepared therein by use of a catalyst made of methylaluminoxane (MAO) and cyclopentadienyl titanium trichloride (CpTiCl₃) system. Xu and Lin, Polymer Preprints, Am. Chem. Soc., Div. Polym. Chem. Vol. 35, 686 and 687 (1994) reports that a random copolymer made from styrene and propylene is prepared by use of a catalyst MgCl₂/TiCl₄/NdCl₃/Al(i-BU)₃. Furthermore, Lu et al., Journal of Applied Polymer Science, Vol. 53, 1453-1460 (1994) reports copolymerization of ethylene and styrene by use of a catalyst TiCl₄/NdCl₃/MgCl₂/Al(Et)₃.

Sernets and Mulhaupt, Macromol. Chem. Phys., Vol. 197, pp. 1071-1083. (1997) describes effect of polymerizing conditions onto the copolymerization of styrene and ethylene by use of a Ziegler Natta catalyst, Me₂Si(Me₄Cp) (N-t-butyl)TiCl₂/methyl aluminoxane. Toshiaki Arai, and Suzuki, Polymer Preprints, Am. Chem. Soc., Div. Polym. Chem, Vol. 38, p. 349 & 350 (1997) and U.S. Pat. No. 5,652,315 (Mitsui Toatsu Chemicals, Inc.) describe ethylene-styrene copolymers produced by use of a bridge type metallocene catalyst. U.S. Pat. No. 5,244,996 (Mitsui Petrochemical Industries, Ltd.) or U.S. Pat. No. 5,652,315 (Mitsui Petrochemical Industries, Ltd.) describes a process for producing an interpolymer made from an α-olefin and an aromatic vinyl monomer (for example, propylene and styrene or butene and styrene), which is also described in DE 19711339 Al, U.S. Pat. No. 5,883,213 (Denki Kagaku Kogyo Kabushiki Kaisha), and others. The above-mentioned interpolymer component preparing processes are incorporated herein for reference. An ethylene/styrene random copolymer disclosed in Polymer Preprints Vo. 39, No. 1, March 1998 by Tohru Aria et al. can also be used as a component of the present invention.

Preferable examples of the catalyst and process suitable for producing a pseudo random interpolymer that is preferably used in the present invention are disclosed in the following specifications: U.S. Pat. No. 5,455,403 filed on Jul. 3, 1990 (EP-A-0416815), U.S. application Ser. No. 547,718 filed on Jul. 3, 1990 (EP-A-468651), U.S. application Ser. No. 702,475 filed on May 20, 1991 (EP-A-514828), U.S. application Ser. No. 876,268 filed on May 1, 1992 (EP-A-520732), U.S. application Ser. No. 8,003 filed on Jan. 21, 1993 (U.S. Pat. No. 5,374,696), U.S. application Ser. No. 82,197 filed on Jun. 24, 1993 (corresponding to WO 95/00526), and U.S. Pat. Nos. 5,055,436, 5,057,475, 5,096,867, 5,064,802, 5,132,380 and 5,189,192. All of them are incorporated herein for reference.

The interpolymer (A) used in the present invention is preferably silane-grafted.

This silane-grafted interpolymer (A) is prepared by using a vinyl silane compound together with a peroxide for promoting the silane grafting. In the present invention, this silane-grafted interpolymer (A) may be a silane-grafted interpolymer (A) generated in a thermoplastic resin composition according to the present invention obtained by melting and mixing an interpolymer (A) which is not silane-grafted, magnesium hydroxide (B), a triazine compound (C), a vinyl silane compound and a peroxide in a manner selected from various known manners.

Specific examples of the above-mentioned vinylsilane compound include γ-methacryloxypropyltrimethoxysilane, vinyltrimethoxysilane, vinyltriethoxysilane, vinyltributoxysilane, vinyltris(β-methoxyethoxysilane), vinyltriacetoxysilane, and methyltrimethoxysilane. Of these examples, preferable are γ-methacryloxypropyltrimethoxysilane, vinyltrimethoxysilane, and vinyltriethoxysilane.

The vinyl silane compound is used usually at a ratio of 0.5 to 2.5%, preferably 0.5 to 2% by weight to 100% by weight of the total of the components (A), (B) and (C). When the vinyl silane compound is used at this ratio, the silane grafting speed is large and further an appropriate silane grating degree is obtained so as to make it possible to yield a molding (such as an electric wire coating layer) having a superior balance between tensile strength and tensile fracture point strength.

As described above, in the present invention, a peroxide is used together with the vinyl silane compound to promote the silane grafting reaction of the interpolymer (A).

The peroxide may be an organic peroxide, specific examples of which include benzoylperoxide, dichlorobenzoylperoxide, dicumylperoxide, di-t-butylperoxide, 2,5-dimethyl-2, 5-di(peroxidebenzoate)hexyne-3, 1,4-bis(t-butylperoxyisopropyl)benzene, lauroylperoxide, t-butylperacetate, 2,5-dimethyl-2,5-di-(t-butylperoxide)hexyne-3, 2,5-dimethyl-2, 5-di(t-butylperoxide)hexane, t-butyl perbenzoate, t-butyl perphenylacetate, t-butyl perisobutyrate, t-butyl per-sec-octoate, t-butyl perpivalate, cumyl perpivalate, t-butyl perdiethylacetate, azobisisobutyronitrile and dimethylazoisobutyrate.

Of these peroxides, preferable are dialkylperoxides such as dicumylperoxide, di-t-butylperoxide, 2,5-dimethyl-2,5-di-(t-butylperoxy)hexyne-3, 2,5-dimethyl-2,5-di(t-butylperoxy)hexane, and 1,4-bis(t-butylperoxyisopropyl)benzene.

The peroxide is used usually at a ratio of 0.05 to 0.15%, preferably 0.01 to 0.1% by weight to 100% by weight of the total of the components (A), (B) and (C). When the peroxide is used at this ratio, the reaction of the interpolymer (A) silane-grafted with the vinyl silane compound can be appropriately promoted.

Triazine Compound (C)

The triazine compound of the present invention is a compound containing a triazine ring. Examples thereof include melamine, ammeline, melam, benzguanamine, acetoguanamine, phthalodiguanamine, melamine cyanurate, melaminepyrophosphate, butylenediguanamine, norbornenediguanamine, methylenedimelamine, ethylenedimelamine, trimethylenedimelamine, tetramethylenedimelamine, hexamethylenedimelamine, and 1,3-hexylenedimelamine. Melamine cyanurate is particularly preferable.

Other Additives

Besides the above-mentioned components, additives as described in the following may be incorporated into the thermoplastic resin composition according to the present invention if necessary: an antioxidant, an ultraviolet absorber, a weather resisting stabilizer, a heat resisting stabilizer, an antistatic agent, a flame retardant, a pigment, a dye, a lubricant and others.

It is more preferable to add a polyhydric alcohol (D) to the composition of the present invention in order to make the flame resistance thereof high.

Examples of the polyhydric alcohol (D) include pentaerythritol, dipentaerythritol, tripentaerythritol, polypentaerythritol, trishydroxyethylisocyanate, polyethylene glycol, glycerin, starch, glucose, cellulose and sorbitol.

Polymer Composition

About the ratio of each of the components contained in the polymer composition of the present invention, the ratio of the interpolymer (A) is from 25 to 59.9% by weight, preferably from 30 to 55% by weight, the ratio of the magnesium hydroxide (B) is from 40 to 60% by weight, and the ratio of the triazine compound (C) is from 0.1 to 20% by weight (in the case that the total amount of the components (A), (B) and (C) is decided to be 100% by weight).

When the polyhydric alcohol (D) is incorporated into the composition, the ratio thereof is preferably from 0.1 to 20%, more preferably from 0.1 to 15% by weight to 100% by weight of the total of the components (A), (B) and (C).

The thermoplastic resin composition according to the present invention is prepared by melting and mixing the above-mentioned components (A), (B) and (C) and the additive(s), which is/are blended if necessary, in a manner selected from various known manners.

For example, the above-mentioned components are simultaneously or successively charged into a Henschel mixer, a V-shaped blender, a tumbler mixer, a ribbon blender or some other blender, mixed, and then melted and kneaded in a monoaxial extruder, a multiaxial extruder, a kneader, a Banbury mixer or some other machine, thereby yielding the composition of the present invention.

By use of a machine having superior kneading performance among the above-mentioned machines, such as a multi axial extruder, kneader or Banbury mixer, a high-quality polymer composition wherein the respective components are homogeneously dispersed can be obtained. At any stage in such a process, the additive(s) such as the antioxidant, can be added if necessary.

Molding

The molding according to the present invention can be yielded by molding the thermoplastic resin composition of the invention, yielded as described above, into a desired shape by a known melting/molding method such as extrusion, rotary molding, calendar molding, injection molding, compression molding, transfer molding, powder molding, blow molding, or vacuum molding.

In the case that the thermoplastic resin composition according to the invention is used as an electric wire sheath or coating, the molding according to the invention is an electric wire sheath or electric wire coating layer. The electric wire sheath or electric wire coating layer is formed on the periphery of an electric wire by a known method such as extrusion.

According to the present invention, it is possible to yield a thermoplastic resin composition having a high flame-resisting effect, flexibility, and a high whiteness, and further a molding thereof.

Since the thermoplastic resin composition of the invention has effects described above, the composition is suitable for various moldings, such as electric wire coating, tape, film, sheet, pipe and blow moldings, and is particularly suitable for an electric wire sheath and an electric wire coating.

### EXAMPLES

The present invention is more specifically described by the following examples.

### Examples 1 and 2, and Comparative Examples 1 and 2

The following were blended in respective amounts (unit: part(s) by weight) described in Table 1: an ethylene/styrene copolymer [styrene content: 30% by weight (=10.3% by mol), and MFR (according to ASTM D 1238 at 190° C. and a load of 2.16 kg): 1.0 g/10-minutes], which is abbreviated to ESI-30, magnesium hydroxide, melamine cyanurate, silicone, γ-methacryloxypropyltrimethoxysilane, which is abbreviated to VMMS, and a peroxide (trade name: Perhexa 3M, manufactured by NOF Corp.). A Banbury mixer was used to melt, knead and granulate the mixture at a resin temperature of 190° C. In this way, pellets of each thermoplastic resin composition were yielded.

Each of the thermoplastic resin compositions was used to calculate A and σ according to the above-mentioned method, and then it was judged whether or not the composition satisfied the expressions (1) and (2).

Moreover, each of the thermoplastic resin compositions was used to measure the fracture point elongation, the fracture point strength and the whiteness thereof. The results are shown in Table 1.

Fracture Point Elongation (EL) and Fracture Point Strength (TS)

According to JIS K 6301, a JIS class-3 dumbbell was used to subject each of the compositions to a tensile test at a span of 20 mm and a tensile speed of 200 mm/minute, thereby measuring the fracture point elongation and the fracture point strength thereof.

Whiteness

On the basis of JIS P 8123, the whiteness of each of the compositions was measured with an automatic Hunter whiteness tester manufactured by Tester Sangyo Co., Ltd.

TABLE 1

| | | Comparative | | Comparative | |
|---|---|---|---|---|---|
| | | Example 1 | Example 1 | Example 2 | Example 2 |
| ESI-30 | | 36 | 36 | 36 | 36 |
| Mg(OH)₂ | | 61 | 61 | 61 | 61 |
| Silicone | | 2 | 2 | 2 | 2 |
| Melamine cyanurate | | | 10 | | 10 |
| VMMS | | 0.2 | 0.2 | | |
| Perhaxa 3M | | 0.03 | 0.03 | | |
| A | Degrees | 60 | 90 | 60 | 90 |
| σ | Mpa | 32 | 34 | 30 | 32 |
| Expression (1) | | x | ∘ | x | ∘ |
| Expression (2) | | x | ∘ | x | ∘ |
| TS | Mpa | 13 | 12 | 11 | 11 |
| EL | % (between | 430 | 430 | 450 | 450 |
| | marked lines) | | | | |
| Whiteness | % | 89 | 97 | 91 | 99 |

∘: Satisfied,
x: Not satisfied

### Examples 3 to 5, and Comparative Examples 3-1, 3-2, 4-1, 4-2, 5-1 and 5-2

In each of Examples 3 to 5, the above-mentioned ESI-30 was used as a thermoplastic resin; in each of Comparative Examples 3-1, 4-1 and 5-1, an ethylene-ethyl acrylate copolymer (trade name: EVAFLEX-EEA, A-710, manufactured by Dupont-Mitsui Polychemicals Co., Ltd.), which is abbreviated to EEA hereinafter, was used as a thermoplastic resin; and in each of Comparative Examples 3-2, 4-2 and 5-2, an ethylene-vinyl acetate copolymer (trade name: EVAFLEX EV360, manufactured by Dupont-Mitsui Polychemicals Co., Ltd.), which is abbreviated to EVA hereinafter, was used. In each of the examples, components were blended in respective amounts (unit: part(s) by weight) described in Table 2, and melted, kneaded and pulverized at a resin temperature of 190° C. with a Banbury mixer to yield pellets of the thermoplastic resin composition. The thermoplastic resin composition was used to calculate A and σ according to the above-mentioned method, and then it was judged whether or not the composition satisfied the expressions (1) and (2). The results are shown in Table 2. A relationship between the torsional rigidity σ and A (maximum angle accepted for the flame-resistance test) of the thermoplastic resin compositions in Table 2 is plotted in FIG. 2.

TABLE 2

| | | Comparative | Comparative | | Comparative | Comparative | | Comparative | Comparative |
|---|---|---|---|---|---|---|---|---|---|
| | Example 3 | Example 3-1 | Example 3-2 | Example 4 | Example 4-1 | Example 4-2 | Example 5 | Example 5-1 | Example 5-2 |
| ESI-30 | 100 | | | 100 | | | 100 | | |
| EEA | | 100 | | | 100 | | | 100 | |
| EVA | | | 100 | | | 100 | | | 100 |
| Mg(OH)₂ | 65 | 65 | 65 | 90 | 90 | 90 | 170 | 170 | 170 |
| Silicone | 6 | 6 | 6 | 6 | 6 | 6 | 6 | 6 | 6 |
| Melamine cyanurate | 8 | 8 | 8 | 8 | 8 | 8 | 8 | 8 | 8 |
| A (degrees) | 45 | 45 | 45 | 60 | 60 | 60 | 90 | 90 | 90 |
| σ (Mpa) | 12 | 20 | 19 | 17 | 30 | 27 | 33 | 50 | 45 |
| Expression (1) | ∘ | x | x | ∘ | x | x | ∘ | x | x |
| Expression (2) | ∘ | x | x | ∘ | x | x | ∘ | x | x |

∘: Satisfied,
x: Not satisfied

1. A thermoplastic resin composition, in which in the case of using samples of an insulated electric wire 3.0 mm in finishing diameter wherein the periphery of a conductor (1.35 mm in outer diameter) made of seven twisted soft copper wires each having a diameter of 0.45 mm is coated with the thermoplastic resin composition of 0.8 mm in thickness to carry out a flame-resistance test at flame-resistance test angles θ of 45°, 60°, and 90°, the maximum angle A out of the flame-resistance test angles θ at which the samples are spontaneously extinguished within 60 seconds from the ignition thereof satisfies the following expression (1):
A≧1.8×σ+13.4 (1)
wherein σ is the torsional rigidity (MPa) of a sheet 2 cm in thickness made of the thermoplastic resin composition at 23° C.

2. A thermoplastic resin composition, in which in the case of using samples of an insulated electric wire 3.0 mm in finishing diameter wherein the periphery of a conductor (1.35 mm in outer diameter) made of seven twisted soft copper wires each having a diameter of 0.45 mm is coated with the thermoplastic resin composition of 0.8 mm in thickness to carry out a flame-resistance test at flame-resistance test angles θ of 45°, 60°, and 90°, the maximum angle A out of the flame-resistance test angles θ at which the samples are spontaneously extinguished within 60 seconds from the ignition thereof satisfies the following expression (2):
A≧1.9×σ+15.4 (2)
wherein σ is the torsional rigidity (MPa) of a sheet 2 cm in thickness made of the thermoplastic resin composition at 23° C.

3. The thermoplastic resin composition according to claim 2, which comprises:
(A) 25 to 59.9% by weight of at least one substantially random interpolymer comprising
(1) 1 to 99% by mol of a polymer unit derived from
(a) at least one aromatic vinyl or vinylidene monomer, or
(b) at least one hindered aliphatic or alicyclic vinyl or vinylidene monomer, or
(c) a combination of at least one aromatic vinyl or vinylidene monomer and at least one hindered aliphatic or alicyclic vinyl or vinylidene monomer, and
(2) 1 to 99% by mol of a polymer unit derived from at least one α-olefin having 2 to 20 carbon atoms,
(B) 40 to 60% by weight of magnesium hydroxide, and
(C) 0.1 to 20% by weight of a triazine compound.

4. The thermoplastic resin composition according to claim 3, wherein the interpolymer (A) is a substantially random interpolymer comprising 5 to 65% by mol of a polymer unit derived from at least one aromatic vinyl or vinylidene monomer, and 35 to 95% by mol of a polymer unit derived from at least one α-olefin having 2 to 20 carbon atoms.

5. The thermoplastic resin composition according to claim 3, wherein the interpolymer (A) is a substantially random interpolymer comprising 5 to 65% by mol of a polymer unit derived from styrene, and 35 to 95% by mol of a polymer unit derived from at least one α-olefin having 2 to 10 carbon atoms.

6. The thermoplastic resin composition according to claim 3, wherein the interpolymer (A) is a pseudo random interpolymer comprising 5 to 50% by mol of a polymer unit derived from at least one aromatic vinyl or vinylidene monomer, and 50 to 95% by mol of a polymer unit derived from at least one α-olefin having 2 to 20 carbon atoms.

7. The thermoplastic resin composition according to claim 3, wherein the interpolymer (A) is a pseudo random interpolymer comprising 5 to 50% by mol of a polymer unit derived from styrene, and 50 to 95% by mol of a polymer unit derived from at least one α-olefin having 2 to 10 carbon atoms.

8. The thermoplastic resin composition according to claim 3, wherein the triazine compound (C) is melamine cyanurate.

9. A molding comprising the thermoplastic resin composition according to claim 3.

10. The molding according to claim 9, which is an electric wire insulator and/or sheath.

11. The thermoplastic resin composition according to claim 1, which comprises:
(A) 25 to 59.9% by weight of at least one substantially random interpolymer comprising
(1) 1 to 99% by mol of a polymer unit derived from
(a) at least one aromatic vinyl or vinylidene monomer, or
(b) at least one hindered aliphatic or alicyclic vinyl or vinylidene monomer, or
(c) a combination of at least one aromatic vinyl or vinylidene monomer and at least one hindered aliphatic or alicyclic vinyl or vinylidene monomer, and
(2) 1 to 99% by mol of a polymer unit derived from at least one α-olefin having 2 to 20 carbon atoms,
(B) 40 to 60% by weight of magnesium hydroxide, and
(C) 0.1 to 20% by weight of a triazine compound.

12. The thermoplastic resin composition according to claim 11, wherein the interpolymer (A) is a substantially random interpolymer comprising 5 to 65% by mol of a polymer unit derived from at least one aromatic vinyl or vinylidene monomer, and 35 to 95% by mol of a polymer unit derived from at least one α-olefin having 2 to 20 carbon atoms.

13. The thermoplastic resin composition according to claim 11, wherein the interpolymer (A) is a substantially random interpolymer comprising 5 to 65% by mol of a polymer unit derived from styrene, and 35 to 95% by mol of a polymer unit derived from at least one α-olefin having 2 to 10 carbon atoms.

14. The thermoplastic resin composition according to claim 11, wherein the interpolymer (A) is a pseudo random interpolymer comprising 5 to 50% by mol of a polymer unit derived from at least one aromatic vinyl or vinylidene monomer, and 50 to 95% by mol of a polymer unit derived from at least one α-olefin having 2 to 20 carbon atoms.

15. The thermoplastic resin composition according to claim 11, wherein the interpolymer (A) is a pseudo random interpolymer comprising 5 to 50% by mol of a polymer unit derived from styrene, and 50 to 95% by mol of a polymer unit derived from at least one α-olefin having 2 to 10 carbon atoms.

16. The thermoplastic resin composition according to claim 11, wherein the triazine compound (C) is melamine cyanurate.

17. A molding comprising the thermoplastic resin composition according to claim 11.

18. The molding according to claim 17, which is an electric wire insulator and/or sheath.
